(19) United States
(12) Patent Application Publication
(10) Pub. No.: US 2018/0075154 A1
(43) Pub. Date: Mar. 15, 2018

(54) PRODUCT AND METHOD FOR PROVIDING INFORMATION IN A MANNER THAT IS EASILY ACCESSIBLE

(71) Applicant: James B. Broselow, Hickory, NC (US)

(72) Inventor: James B. Broselow, Hickory, NC (US)

(21) Appl. No.: 15/602,476

(22) Filed: May 23, 2017

Related U.S. Application Data
(60) Provisional application No. 62/394,384, filed on Sep. 14, 2016.

(51) Int. Cl. G06F 17/30; H04L 29/06; H04L 29/08

(52) U.S. Cl. CPC G06F 17/30879; G06K 7/1413; H04L 67/34; H04L 63/083

(57) ABSTRACT

A method and product for providing ready access to information that includes the steps of uploading the information to a server and creating a physical object that is readable by a digital scanning device containing a barcode representing a combination of a URL, a server address and optionally a unique passcode to the URL. The barcode on the object is scanned to access the information stored at the URL by use of the passcode.

### CROSS-REFERENCE TO RELATED APPLICATION AND PRIORITY

This application claims priority to U.S. Provisional Application No. 62/394,384 filed Sep. 14, 2016, the contents of which are incorporated by reference herein.

### TECHNICAL FIELD AND BACKGROUND OF THE INVENTION

This invention relates to a product and method for providing secure information in a manner that is easily accessible when necessary or desirable. In one embodiment of the invention, information is uploaded to a server and a sticker is printed containing a barcode representing a combination of a URL of the server and a unique passcode. Access to that particular information is restricted to scanning the sticker with an Internet connected device.

The establishment of the Internet along with unprecedented ability to store information has revolutionized the basic concept of a “reference.” Internet access is available as a matter of course in virtually every public and most private areas. Data storage has become very inexpensive and is thus, a commodity affordable to every business and to most individuals. Numerous methods of storing and accessing data have been developed and many more will be developed in the future.

From books to electronic encyclopedias, simple text to multimedia, PCs to mobile computers—the capacity to store and access vast amounts of information is becoming increasingly commonplace and available to more and more businesses and individuals. Yet, the abundance of resources and the very inexpensive means of storing and retrieving digital data can create its own barriers.

How does an individual find exactly the needed or desired information without regard to language, education or technology skills? The expectations and business practices of enterprises that profit from the use of digital information in its varying forms often proceed ahead of the ability of many members of society and other businesses to fully use the information in a meaningful manner.

The ability to find information in almost any language, to have the information displayed as words, text to speech, pictures, graphics, animations or videos in many ways can eliminate or ease the limitations of most humans seeking to learn and understand. The limitations can then be viewed as not so much how to customize the knowledge for almost any situation, but rather how to access the exact knowledge that is needed at any time, or place or circumstance. A “search engine”, such as Google, requires, both time and effort and a fundamental knowledge of how it works in order to search and continuously narrow the choices until the desired information is located.

In computerized systems, medical computer systems being a good example, “contextual searches” have been developed to narrow the search focus. For example, if an electronic system already knows that a patient has a diagnosis of diabetes, the search engine looking for general medical information will filter for diabetes. However, in the physical world, context can be infinitely broad and can encompass any situation from being stuck in an elevator to needing to perform effective CPR in an emergency situation. Perhaps, a particular instruction or repair manual is needed for an obsolete machine appliance or other device or a repairperson needs to know exactly how wiring in a particular house should be installed. The challenge, then, is how to store and then find the relevant information within the context of everyday life.

Many websites contain vast collections of repair and instruction manuals, software updates, patches and supplements, often identified only by reference to model or serial numbers or other information that may be no longer available. Sifting through this amount of information can be taxing even for knowledgeable internet and computer users and simply beyond the capabilities of many individuals.

A large step towards solving this basic need would be to provide the capability to find or create the specific information needed, electronically “tag” that information, for example, by using a barcode aimed at the relevant digital address, provide a QR code containing that URL, print that URL onto a “sticker” and then apply the sticker to a “thing” or “place” where that information may be needed. At any subsequent time, the QR code can be scanned, the relevant digital address accessed and the electronically tagged information downloaded onto a digital device, such as a smart phone, pad or other device. Stickers maybe used in a variety of ways that facilitate use by individuals without significant computer or internet use skills, as described below.

### SUMMARY OF THE INVENTION

It is therefore an object of the present invention to provide a means by which specific information can be provided and associated with a specific location, object or function.

It is another object of the invention to provide a means by which specific information can be provided and retrieved using any one of a number of digital devices when and where needed to the exclusion of other unnecessary information.

It is another object of the invention to facilitate use of the internet to convey or retrieve specific information by individuals without significant computer or internet use skills.

These and other objects and advantages of the invention are achieved by providing a method by which information is uploaded to or accessed on a server. A digitally readable physical display object such as a label, tag or sticker is provided that contains coded symbols, such as a barcode, that represent a combination of a URL and a unique passcode. Access to that particular information is accessed, for example, by scanning the sticker with an Internet-connected device, such as a barcode scanner or a mobile phone equipped with an application that allows various types of barcodes to be read. Scanning the sticker, accesses the server via the URL. Information associated with the URL is downloaded and is accessible via the scanner, mobile phone or other digital device capable of accessing the server via the URL.

### BRIEF DESCRIPTION OF THE DRAWING FIGURES

The present invention is best understood when the following detailed description of the invention is read with reference to the accompanying drawings, in which:

FIG. 1 is a flow diagram illustrating one preferred method of carrying out the invention;

FIG. 2 illustrates that a pad of digitally readable stickers containing, for example, QR codes is made available for distribution by purchase or otherwise;

FIG. 3 is a view illustrating that the QR code is scanned to access a specific server;

FIG. 4 is a view illustrating that after desired content is uploaded to the server, the digitally-readable sticker can be placed in a location where it can be accessed and the content downloaded;

FIG. 5 is a view illustrating that information located on the server can later be accessed and downloaded by scanning onto a digital device.

### DETAILED DESCRIPTION OF THE PREFERRED EMBODIMENT

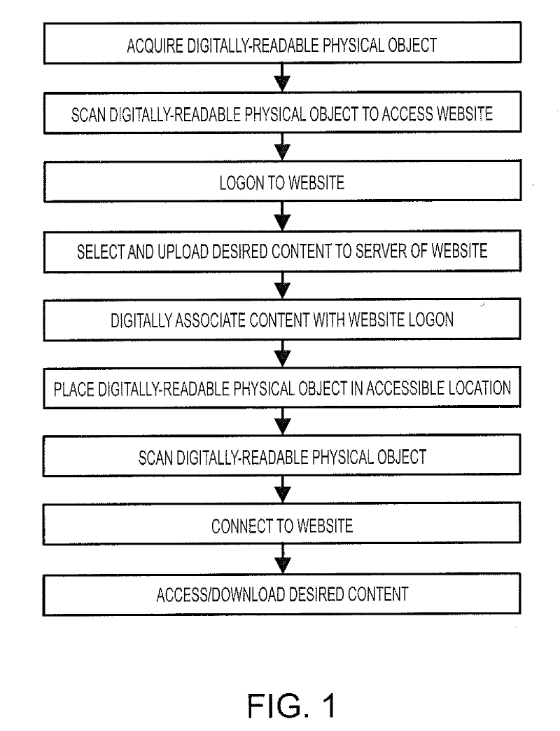

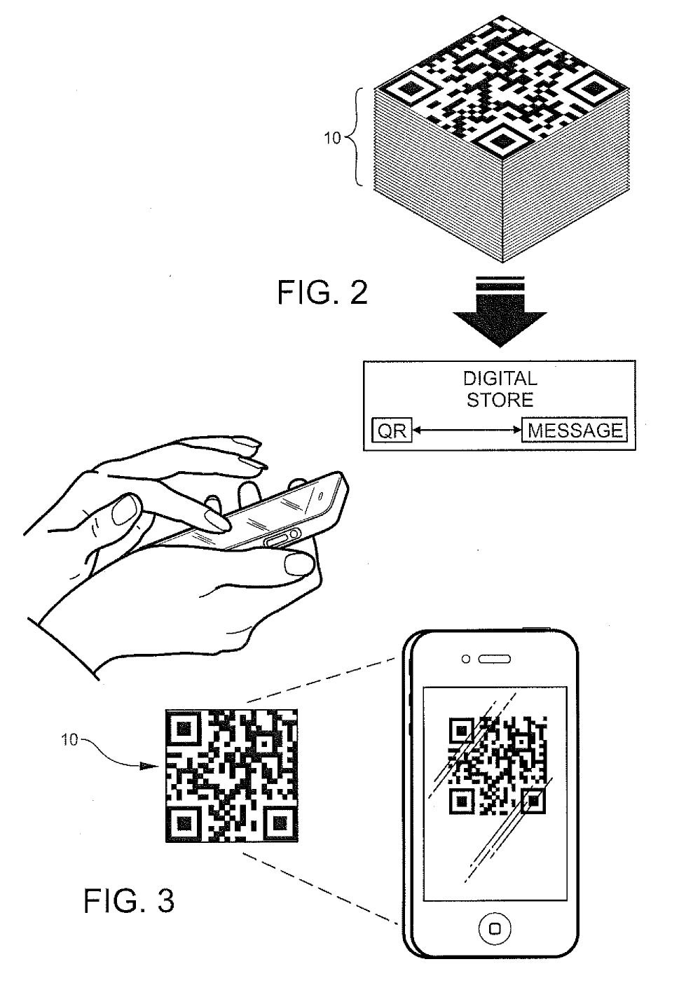

Referring now to FIG. 1, a preferred embodiment of the method according to the invention is shown. In a broad sense, a physical object is provided with a means of being digitally read. This can be any form of scannable bar code, QR code or other digitally readable device. By way of example, a pad of stickers 10 as shown in FIG. 2 may be provided with a QR code and sold or otherwise distributed for use. The QR code includes a means of accessing a server onto which any desired content maybe uploaded, such as a URL. In addition, the QR code may direct uploaded data to a specific predefined folder for later retrieval. This content may be text, images, audio or audiovisual material contained on a digital storage device that is capable of uploading that content to the server, for example a smart phone, pad or the similar digital device. At the server, the user enters logon information and is then invited to upload the desired content onto the website of the server, where it is stored for future retrieval. See FIG. 3. The uploaded content is digitally associated with the particular URL or other identifying information on the QR code. The sticker 10 is then, placed in an accessible location where it can later be digitally scanned.

### Example 1

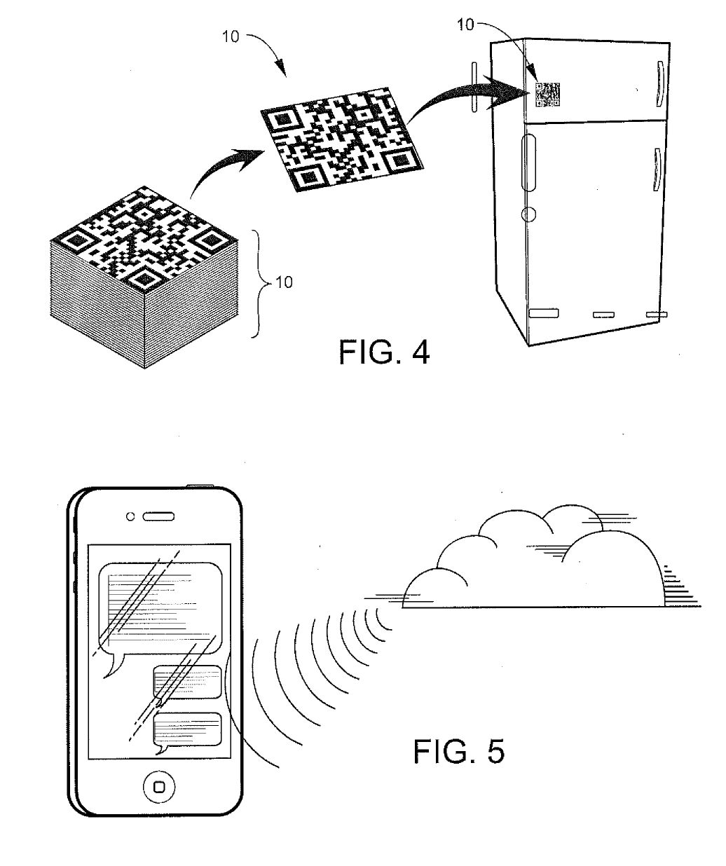

By way of specific illustration, assume that a parent wishes to provide dinner and homework instructions to a child when the child arrives at home. The parent either prepares a message by means of an audio recording or text message, accesses the server, uploads the recording or message and then places the sticker on the refrigerator. See FIG. 4. The child can later access the message by scanning the sticker. The QR code connects to the website and downloads the recording or message for the child, who is informed that sandwiches are in the refrigerator and that the homework has to be finished by a certain time. See FIG. 5.

Various options may be made available. The price of the pad of stickers may include the cost of accessing the system as described above, or payment may be required via a prepaid account or credit card during each access/upload event. Where the content is intended to be accessed only by certain individuals or classes of individuals, a passcode may be provided via a separately transmitted text message or email in order to access and download the stored content.

If the content is intended for only a single download, the system can be programmed to automatically delete the message.

The range of uses is limited only by the ability to upload and then download specified content as illustrated in the further examples set out below.

### Example 2

An electrician, cable installer or other provider, for example, arrives at a new location and needs to know the location and type of electrical, Internet or TV wiring in the house, A “sticker” has previously been applied to, for example, a TV box or remote control, which the service provider can access with a smart phone to obtain the needed information. If the wiring is modified during that visit, the information can then be updated for future reference by updating the information or providing a new sticker to take the place of the obsolete one. The downloaded information can also reference previous problems, repair instructions, parts numbers and where inventoried or any other useful information.

### Example 3

A sticker can be provided with a QR code that includes a URL to a website that contains medical information concerning a specific patient. This information may include current and past medical conditions, prescriptions and drug interactions, vital statistics, contact information and similar other information. The sticker can be placed next to a patient bed, on a chart or in any other suitable location.

### Example 4

QR code stickers can be applied both to “things” and also, to sections of books that duplicate specific multimedia information, for example, a recipe book with the names of favorite recipes, each containing a sticker that shows not only the ingredients but also perhaps a video showing how to prepare the item. In this context, the term “sticker” refers to a specific printed area of page, and not necessarily to a physical object that is adhered to the book page.

### Example 5

Coded stickers on family heirlooms can relate the stories associated with them, antiques that show the value for family or insurance purposes—the possibilities are almost endless when some person, somewhere, might want to retrieve exact information, virtually in seconds, simply by scanning a sticker into a cell phone.

### Example 6

A QR code sticker maybe provided for use when a person is suddenly required to do CPR. The “sticker” is placed on the wall of a hospital room or on the defibrillator and a video of the CPR technique is immediately seen and heard as a guide to the proper rate and technique of hands-only CPR. The Automated External. Defibrillation (“AED”) itself has a video showing exact instructions regardless of the language capabilities of the responder at hand.

### Example 7

A barcode “emergency sticker” maybe applied to a wall on the interior of an elevator. A person trapped in a stalled elevator can capture the emergency QR code using a cell phone and immediately access the relevant safety information, which may be a phone number, website or instructions regarding where an alarm is located.

### Example 8

A QR code sticker can be applied to a pet collar. If the pet is lost, the sticker applied to the collar can be scanned with a cell phone to link the finder to the contact information of the owner.

### Example 9

In a disaster setting, a pediatric patient may need a respirator, but the only ones available are adult models. A “pediatric” QR code sticker applied to the respirator can be scanned to show how to adapt that machine for a child. The information can be updated as needed at the server without requiring replacement of the sticker.

### Example 10

An adult may record a video explaining his wishes regarding life support. The recording can then be accessed by scanning a sticker within that person's wallet or maintained by a relative.

### Example 11

In another embodiment of the invention, a sticker can be manufactured for sale that includes a pre-selected passcode. The passcode can be used to access a specific website, where a person can, for example, dictate or type into a specified location on the website a message or the like. Later, the sticker can be scanned and the website accessed only with the passcode, thereby allowing the message to be listened to or read only by individuals with knowledge of the passcode. Alternatively, the sticker can be sold without a passcode, thus allowing the purchaser to select a passcode or his or her choosing as a part of the method of using the sticker to convey information.

A product and method for providing secure information in a manner that is easily accessible when necessary or desirable according to the invention have been described with reference to specific embodiments and examples. Various details of the invention maybe changed without departing from the scope of the invention. Furthermore, the foregoing description of the preferred embodiments of the invention and best mode for practicing the invention are provided for the purpose of illustration only and not for the purpose of limitation, the invention being defined by the claims.

I claim:

1. A method for providing ready access to information, comprising the steps of:
(a) creating a digitally readable physical object that includes a scannable digital code for accessing a predetermined address of a server of a website;
(b) determining selected information in digital form to be stored in the server of the website for digital retrieval;
(c) logging on to the website;
(d) accessing the server associated with the website;
(e) uploading the selected information to the server;
(f) digitally associating the selected information with a digital address on the website and on the digitally readable physical object;
(g) placing the digitally readable physical object in an accessible location for later access;
(h) scanning the digitally readable physical object with an internet-accessible digital device;
(i) connecting the internet-accessible digital device with the predetermined address of the server; and
(j) downloading the selected information from the server.

2. A method according to claim 1, wherein the step of creating the digitally readable physical object comprises creating a sticker for being adhered to a surface.

3. A method according to claim 2, wherein the step of creating the digitally-readable physical object comprises creating a pad formed of a multiplicity of overlaid stickers for being adhered to a surface and each sticker having thereon a scannable digital code for accessing a discrete predetermined address of a server of a website;

4. A method according to claim 1, wherein the scannable digital code is a barcode.

5. A method according to claim 1, wherein the scannable digital code is a QR code.

6. A method according to claim 1, and including the step of creating a discrete passcode for being associated with the predetermined address of the server.

7. A method according to claim 1, and including the step of deleting the selected information from the server after it is downloaded.

8. A method according to claim 1, and including the step of saving the selected information on the server after it is downloaded.

9. A method according to claim 1, and including the step of updating the selected information at the server for subsequent access and download with the same digitally readable physical object.

10. A product usable for providing ready access to digitally stored information, comprising:
(a) a digitally-readable physical object having printed thereon a digital code usable with a digital device capable of scanning a digital code and accessing a server of a website; and
(b) the server of the website adapted for storing selected information uploaded by a user having access to the digitally readable physical object.

11. A product according to claim 10, and including a pad formed of a multiplicity of overlaid stickers for being adhered to a surface, each sticker having thereon a scannable digital code for accessing a website and a discrete predetermined address of the server of the website.

12. A product according to claim 10, and including a discrete passcode for being associated with the predetermined address of the server.

13. A product according to claim 10, wherein the scannable digital code is a barcode.

14. A product according to claim 10, wherein the scannable digital code is a QR code.
